(19) United States
(12) Patent Application Publication
(10) Pub. No.: US 2009/0157517 A1
(43) Pub. Date: Jun. 18, 2009

(54) ADJUSTABLE BALANCE LIMIT PREPAID PRESENTATION INSTRUMENT

(75) Inventor: Stuart G. Davis, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 11/957,034

(22) Filed: Dec. 14, 2007

(51) Int. Cl. G06Q 40/00; G06Q 20/00

(52) U.S. Cl. 705/17; 705/39

(57) ABSTRACT

This disclosure describes, generally, methods and systems for providing an adjustable balance limit prepaid presentation instrument is described. The method includes receiving a request for the adjustable balance limit prepaid presentation instrument and obtaining customer information. The method further includes, processing the customer information with a processor to determine a risk level associated with changing a funding limit associated with the prepaid presentation instrument. The method further funds the adjustable balance limit prepaid presentation instrument to up to a maximum of the assigned funding limit using a variety of funding sources.

### FIELD OF THE INVENTION

The present invention relates, in general, to prepaid presentation instruments, and more particularly, to prepaid presentation instruments with adjustable balance limits.

### BACKGROUND

Presently, prepaid presentation instruments (e.g., prepaid credit cards, gift cards, etc.) have fixed balance limits associated with the presentation instrument. As such, when a customer obtains a presentation instrument with a fixed balance limit of, for example, $100.00, the customer is only able to reload the instrument with funds up to $100.00. This is true even if the customer desires to load additional funds above the balance limit. Accordingly, the present invention addresses this and other problems associated with current implementations.

### BRIEF SUMMARY

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

An exemplary method of providing an adjustable balance limit prepaid presentation instrument is described. In one embodiment, the method includes receiving a request for the adjustable balance limit prepaid presentation instrument and obtaining customer information. Processing the customer information with a processor to determine a risk level associated with changing a funding limit associated with the prepaid presentation instrument. The adjustable balance limit prepaid presentation instrument is funded to up to a maximum of the assigned funding limit using a variety of funding sources.

An alternative exemplary embodiment of a method of converting a fixed limit prepaid presentation instrument into an adjustable balance limit prepaid presentation instrument is described. According to one embodiment, the method includes presenting a customer's preexisting fixed limit prepaid presentation instrument. In an alternative embodiment, the issuer of the fixed limit prepaid card may select the card in which the issuer desires to convert to a adjustable limit prepaid card. The method further includes analyzing the customer's usage history associated with the fixed limit prepaid presentation instrument. Furthermore, based on the usage history, the method derives a new funding limit, and applies the new funding limit to the prepaid presentation instrument.

An exemplary embodiment of a system for providing an adjustable balance limit prepaid presentation instrument is described. In one embodiment, the system includes a point-of-sale (POS) device configured to receive a request for an adjustable balance limit prepaid presentation instrument. The system further includes an account processor connected with the POS device via a financial network. The account processor may be configured to obtain customer information. The account processor may include a decision engine configured, based on the customer information, to assign a funding limit to the adjustable balance limit prepaid presentation instrument. The system may further include a banking network connected with the account processor. The bank network may be configured to fund the adjustable balance limit prepaid presentation instrument to up to a maximum of the funding limit.

Another exemplary embodiment of a machine-readable medium of providing an adjustable balance limit prepaid presentation instrument is described. In one embodiment, the machine-readable medium has sets of instructions which, when executed by a machine, cause the machine to receive a request for the adjustable balance limit prepaid presentation instrument and obtaining customer information. The machine further causes the machine, based on the customer information, to assign a funding limit to the adjustable balance limit prepaid presentation instrument. The machine is further caused to fund the adjustable balance limit prepaid presentation instrument to up to a maximum of the assigned funding limit using a variety of funding sources.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a flow diagram illustrating a method of providing an adjustable balance limit prepaid presentation instrument, in accordance with various embodiments of the invention.

FIG. 2 is a flow diagram illustrating a method of converting a fixed limit prepaid presentation instrument into an adjustable balance limit prepaid presentation instrument, in accordance with various embodiments of the invention.

FIG. 3 is a block diagram illustrating a system for providing an adjustable balance limit prepaid presentation instrument, in accordance with various embodiments of the invention.

FIG. 4 is a block diagram illustrating a presentation instrument, in accordance with various embodiments of the invention.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

According to aspects of the present invention, adjustable prepaid presentation instruments are described. “Adjustable” has reference to a prepaid funding limit of the account associated with the presentation instrument. For example, a customer may be issued a prepaid presentation instrument with a fixed funding limit of, for example, $100.00. However, after using the instrument for some time, the customer decides that they are in need of a higher funding limit. Instead of getting an additional instrument or getting an entirely new instrument, it would be more convenient to simply increase or “adjust” the customer's current presentation instrument's funding limit. Whether the instrument funding balance can be increased and/or by how much can be determined based on a variety of factors designed to rate the worthiness of the customer.

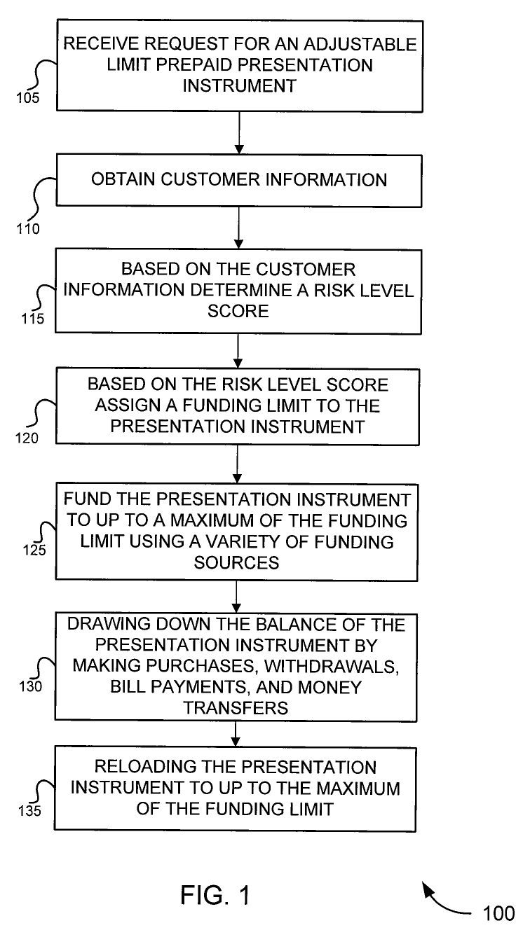

Turning now to FIG. 1 which illustrates one embodiment of a method 100 of providing an adjustable balance limit prepaid presentation instrument. In one embodiment, a prepaid presentation instrument may be associated with a variety of account types, such as for example, a prepaid credit card, a stored-value card, a gift card, an e-wallet, a virtual prepaid card, an prepaid card embedded in a device, etc. At process block 105, a request for an adjustable funding limit prepaid presentation instrument may be received directly or indirectly by a card issuer from a customer and/or customer representative. At process block 110, information about the customer may be obtained. In one embodiment, the customer information may include funding amounts and/or patterns of current and/or past prepaid accounts, payment patterns of bills and other obligations, the velocity of the customer's cash flow, the frequency and types of transactions the customer is engaged in and the like. In addition, the customer's credit score, citizenship, residency, identification provided (e.g., state driver's license, passport, foreign identification, social security number/card, etc.), duration of the relationship with the card issuer and the like. In other words, any information may be obtained that may assist the card issuer in determining how capable the customer will be in consistently funding the prepaid presentation instrument.

At process block 115, the collected customer information is analyzed to determine a risk level score for the customer. In one embodiment, the risk level score may be a range score (e.g., from 1 to 100 points); alternatively, the score may be based on assessed value categories (e.g., poor, fair, average, good, excellent, etc.). Nonetheless, a risk level score may be assigned to each customer initially applying for an adjustable limit prepaid instrument or attempting to convert an existing card into an adjustable limit card. At process block 120, based on the risk level score associated with the customer, a funding limit for the prepaid instrument can then be assigned.

In an alternative embodiment, the funding limit may be assigned based on a sliding scale determined by the duration of the relationship of the customer with the card issuer. For example, if the customer has the prepaid account for up to 30 days, the funding limit may be $100.00; from 30 to 90 days the funding limit may be $300.00, and so forth. Accordingly, the longer the relationship the customer has with the card issuer, the higher the funding limit.

In a further embodiment, the account may be a checking account, a savings account, a money market account, etc. These accounts may be assigned a deposit limit, which limits the amount of funds that can be deposited into the account. For example, the financial institution may desire to limit the amount of funds they take from a customer, thus limiting their potential liability and/or to manage the financial institution's balance sheet. Alternatively, the customer or the financial institution may only want an account funded up to a federally backed amount (e.g., $100,000). Nonetheless, the adjustable funding limit principles discussed above may be applied to accounts other than prepaid presentation instrument accounts.

At process block 125, after the funding limit has been assigned to the presentation instrument account, the instrument may be funded up to the new limit. The funding may be from a variety of funding sources. For example, the customer may fund the presentation instrument using a personal check, money order, casher's check, credit card, electronic funds transfer (EFT), a online payment account, a checking account, a savings account, a money market account, etc. The customer may then draw down the balance of the prepaid instrument by making purchases and/or money transfers (process block 130). Thus, as additional space for funding the instrument becomes available, the customer may reload the instrument to up to a maximum of the funding limit (process block 135).

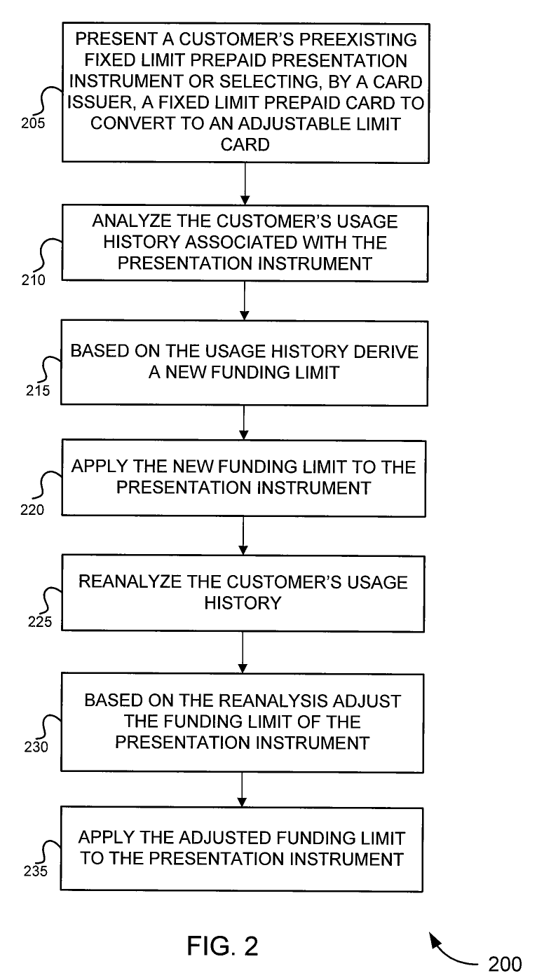

Describing FIG. 2 which illustrates one embodiment of a method 200 of converting a fixed limit prepaid presentation instrument into an adjustable balance limit prepaid presentation instrument. At process block 205, a customer may present the card issuer of a customer's preexisting prepaid card with a request to convert their instrument into an adjustable limit instrument. In an alternative embodiment, the issuer of the fixed limit prepaid card may select the card in which the issuer desires to convert to a adjustable limit prepaid card. At process block 210, the customer's usage history associated with the preexisting presentation instrument may be analyzed. The analysis may include funding history, frequency of use, transaction history, etc.

Based on the analysis of the usage history, a new funding limit may then be derived (process block 215). In one embodiment, consideration may be given to a customer's requested funding limit. Furthermore, additional customer information may be collected and may then be used in conjunction with the usage history to determine the new funding limit.

At process block 220, the new funding limit may be applied to the instrument account. In one embodiment, the customer may be able to immediately fund the prepaid presentation instrument to up to a maximum of the funding limit. Alternatively, the customer may be required to wait a given period of time before the new funding limit is available. In a further embodiment, the customer may desire that the funding limit be increased. At process block 225, the customer's usage history and other customer information may be reanalyzed to derive a new funding limit. In an alternative embodiment, the card issuer may initiate the reanalysis in order to offer the customer a high funding balance or reduce the funding balance. Furthermore, the reanalysis may occur numerous occasions for a given prepaid presentation instrument.

Accordingly, at process block 230, based on the reanalysis, the funding limit may be adjusted. In one embodiment, the funding limit may remain the same, increase, or decrease depending on the results of the analysis. At process block 235, the adjusted funding limit, if necessary, may be applied to the presentation instrument account. Thus, the customer may fund the instrument to up to a maximum of the adjusted funding limit.

In an alternative embodiment, the prepaid presentation instrument may have an associated monthly fee. For example, the customer may be required to pay a monthly, quarterly, annual, etc. fee (e.g., $3 dollars) as long as the customer keeps the prepaid presentation instrument active. Often such a fee can discourage the customer from using the prepaid presentation instrument, and can lead the customer to cancel the account.

Accordingly, in one embodiment, the monthly fee may be adjusted based on the usage of the presentation instrument and/or the duration of the relationship with the customer. For example, the fee may start out at $4 dollars per month for the first 3 months. After the customer has used the prepaid presentation instrument for those three months, the monthly fee may be reduced to $3 dollars per month. Thus, as the customers have the prepaid account for a longer period of time, the lower the monthly fee is until there may not be a monthly fee at all.

Alternatively, the monthly fee may be adjusted based on the usage of the presentation instrument account by the customer. For example, the more the prepaid account is used and/or the more the account is funded, the lower the monthly fee would be. Conversely, the less the account is used and/or the less the account is funded the higher the monthly fee would be. Accordingly, a customer that is more valuable (i.e., funds and using the prepaid account more) would be rewarded with a lower monthly fee. Thus, the fee structure provides an incentive for the increased and/or more frequent use of the prepaid account.

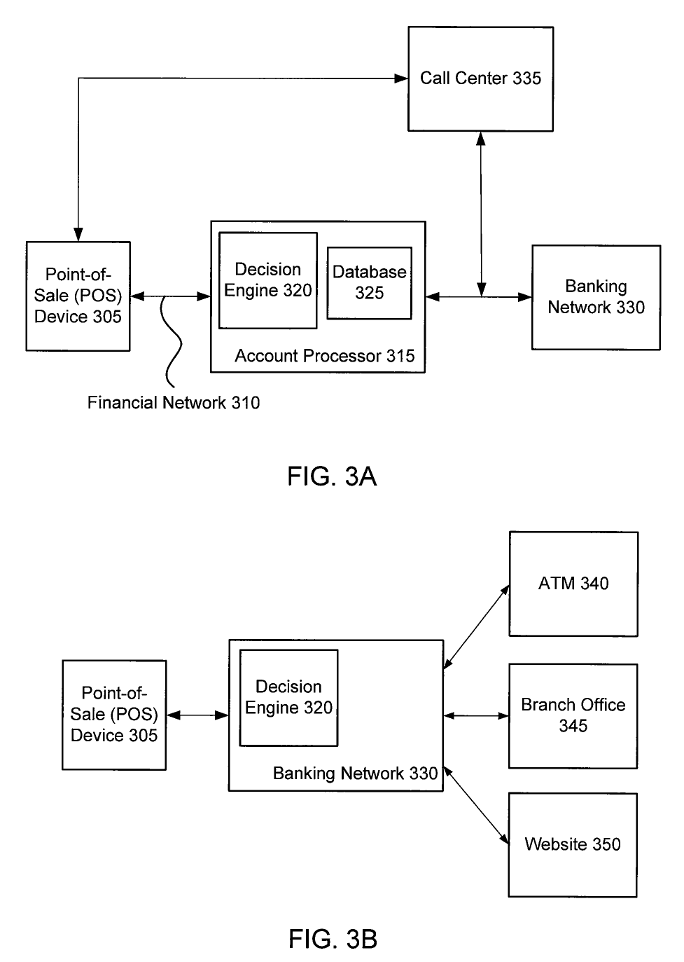

Now describing FIG. 3A which illustrates one embodiment of a system for providing an adjustable balance limit prepaid presentation instrument. In one embodiment, the system may include a point-of-sale (POS) device 305. POS 305 may receive requests for new adjustable limit presentation instruments and/or a request to convert a fixed limit presentation instrument to an adjustable limit presentation instrument. In one embodiment, the POS device 305 may be a customer facing device, a retail store checkout device, an automated teller device (ATM), a web interface, etc.

Upon receipt of the request at the POS device 305, the POS device 305 may then transmit the information related to the request via a financial network 310 to an account processor 315. In one embodiment, financial network 310 may be the VISA™ network, Discover™ Pulse network, MasterCard™ network, Greendot™, InComm™, NYCE™ network, etc. The network may depend on the card issuer used to issue the prepaid presentation instrument account and their network relationships.

In one embodiment, account processor 315 may receive the request from financial network 310. Account processor 315 may be configured to activate new accounts, store account profile information in a database 325, maintain detailed accounting information related to prepaid account, etc. In one embodiment, account processor 315 may include a decision engine 320. Decision engine 320 may be configured to implement methods 100 and 200 described above. In one embodiment, decision engine 320 may derive a funding limit to be associated with a new prepaid account and/or derive a new funding limit to be adjusted for an existing account. Decision engine 320 may access customer account usage history from database 325 in order to make funding limit determinations.

In a further embodiment, account processor 315 may be connected with banking network 330 and call center 335 (or other customer interface). In one embodiment, banking network 330 may perform regulatory compliance checks for the customer or potential customer. For example, banking network 330 may perform anti-money laundering (AML) checks, know your customer (KYC) checks, etc. Upon verification of the customer, banking network 330 may send an authorization to account processor 315 indicating that the prepaid account may now be created.

Furthermore, as the customer uses the prepaid account at, for example, POS device 305, a funding request is transmitted to account processor 315. Account processor 315 then transmits a “good funds” or “bad funds” message to banking network 330, which then acts on the funding request accordingly. Furthermore, account processor 315 may transmit a message indicating the available (or open to load) amount. In addition, when a funding limit adjustment is made through decision engine 320, account processor 315 may inform banking network 330 of the change in the funding limit.

In an alternative embodiment, FIG. 3B illustrates a system for providing an adjustable balance limit prepaid presentation instrument. This system removes the account processor and simply has the customer work directly with banking network 330. Banking network 330 includes the decision engine 320 for making determinations on funding limits for prepaid presentation instrument accounts. Furthermore, the customer may utilize funds from the presentation instrument at ATM 340, branch office 345 and/or website 350. In addition, a customer may make funding limit adjustment requests via POS 305, ATM 340, branch office 345 and/or website 350.

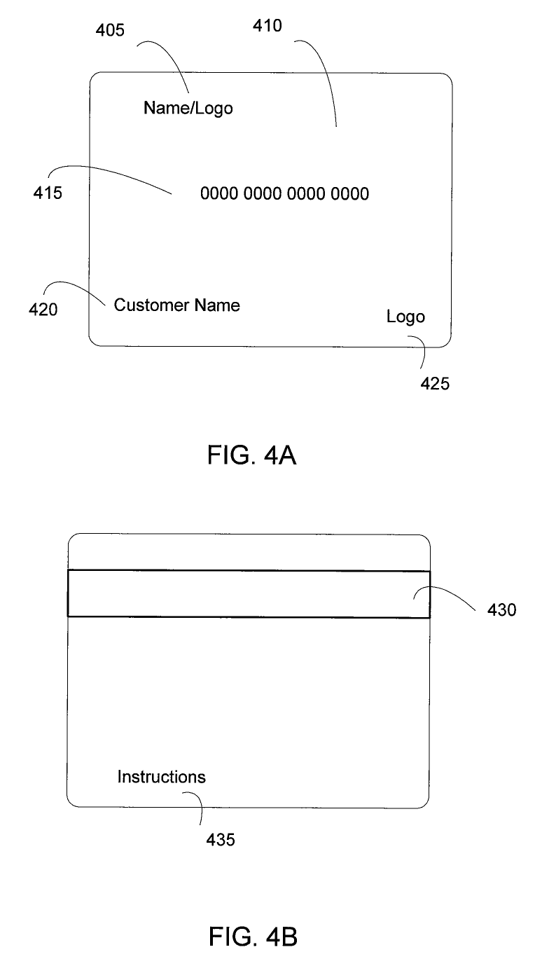

Turning now to FIGS. 4A and 4B which illustrate a front and back view, respectively, of a presentation instrument according to embodiments of the present invention. FIG. 4A may include an issuing bank and/or company name/logo 405, a presentation instrument body 410, an account number 415, a customer name 420, and a financial institution logo 425. In one embodiment, name/logo 405 may be the name and logo of the store for which, for example, a reloadable gift card is associated.

In a further embodiment, account number 415 may be a number used to identify the prepaid account associated with the presentation instrument. Furthermore, customer name 420 may be the name of the customer associated with the presentation instrument account. Additionally, logo 425 may be the logo of the financial institution and/or company that issued the presentation instrument or logo 425 may also be a holograph associated with the financial institution and/or company.

Referring now to FIG. 4B which includes magnetic stripe 430 and instructions 435. Magnetic stripe 430 may be encoded with account and customer information for the adjustable prepaid presentation instrument. Magnetic stripe 430 may also be replaced with a barcode, an RF transmitter, a smart device, proximity device, optical memory device, etc. Instructions 435 may include instructions on how to use the presentation instrument. Further, instructions 435 may provide contact information (e.g. telephone number, web address, mailing address, etc.) of the issuing financial institution and/or company. It should be noted that any or all of the items included in FIGS. 4A and 4B are optional, and may be removed and/or rearranged according to embodiments of the invention.

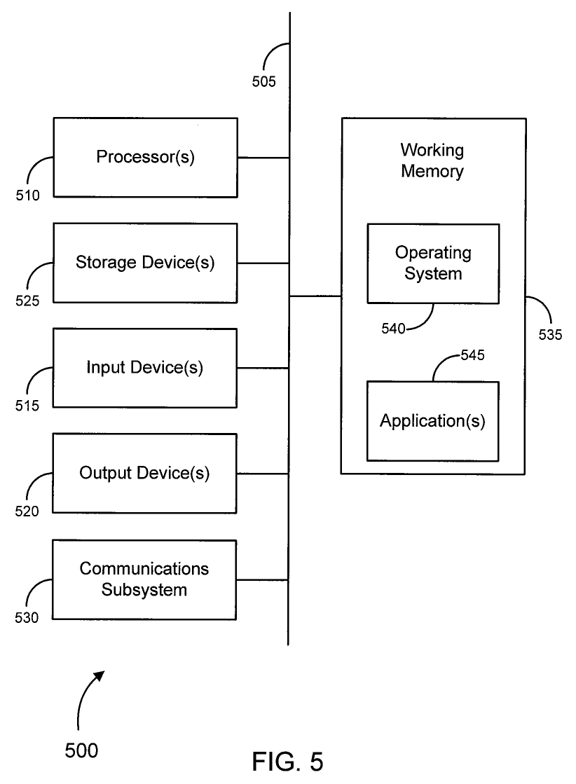

FIG. 5 provides a schematic illustration of one embodiment of a computer system 500 that can perform the methods of the invention, as described herein, and/or can function as, for example, POS 305 (FIG. 3) and/or account processor 315 (FIG. 3). It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540 and/or other code, such as one or more application programs 545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 500) to perform methods of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another machine-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 500, various machine-readable media might be involved in providing instructions/code to processor(s) 510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 525. Volatile media includes, without limitation, dynamic memory, such as the working memory 535. Transmission media includes coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc., carried by the signals) to the working memory 535, from which the processor(s) 505 retrieves and executes the instructions. The instructions received by the working memory 535 may optionally be stored on a storage device 525 either before or after execution by the processor(s) 510.

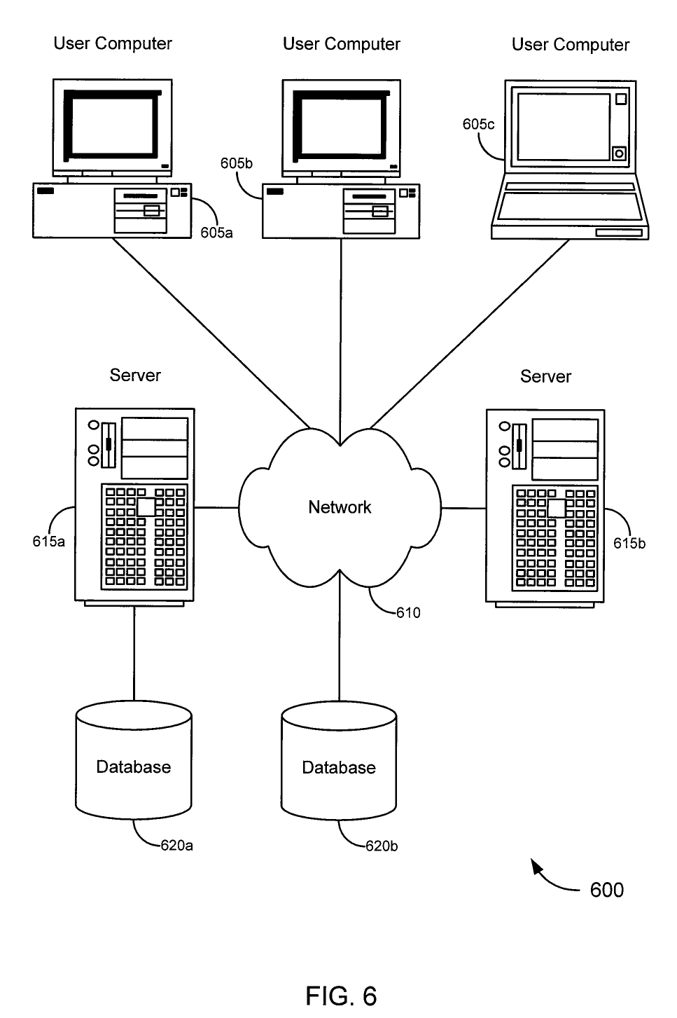

A set of embodiments comprises systems for providing an adjustable balance limit prepaid presentation instrument. Merely by way of example, FIG. 6 illustrates a schematic diagram of a system 600 that can be used in accordance with one set of embodiments. The system 600 can include one or more user computers 605. The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially-available protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 605 and/or another server 615. In some embodiments, an application server can create web pages dynamically for displaying the information in accordance with embodiments of the invention, such as a web interface for website 350 (FIG. 3). Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement methods of the invention incorporated by an application running on a user computer 605 and/or another server 615. Alternatively, as those skilled in the art will appreciate, a file server can include all necessary files, allowing such an application to be invoked remotely by a user computer 605 and/or server 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computerized method of providing an adjustable balance limit prepaid presentation instrument, the method comprising:
receiving a request for an adjustable balance limit prepaid presentation instrument;
obtaining customer information;
processing the customer information with a processor to determine a risk level associated with changing a funding limit associated with the prepaid presentation instrument;
assigning the funding limit to the adjustable balance limit prepaid presentation instrument; and
funding the adjustable balance limit prepaid presentation instrument to up to a maximum of the assigned funding limit.

2. The method of claim 1 further comprising using the adjustable balance limit prepaid presentation instrument for purchases, withdrawals, bill payments, and money transfers which draw down funds leaving an amount open to load on the adjustable balance limit prepaid presentation instrument to up to the maximum of the funding limit.

3. The method of claim 2, further comprising funding the adjustable balance limit prepaid presentation instrument by the amount open to re-load.

4. The method of claim 1, wherein the adjustable balance limit prepaid presentation instrument is at least one of a prepaid credit card, a gift card, a stored-value card, an e-wallet, a payment instrument embedded in an electronic device, and a virtual prepaid card.

5. The method of claim 1, wherein the variety of funding sources include at least one of a bank account, a saving account, a wire transfer, money transfer, and cash.

6. The method of claim 1, wherein the customer information is at least one of a credit score, the customer's demographics, the customer's spending patterns, the customer's payment patterns, and duration of relationship with the customer.

7. The method of claim 6 further comprising, based on the customer information, assigning the customer a risk level score.

8. The method of claim 7, wherein the funding limit is changed by at least one of increasing, decreasing, and remaining the same as determined by the risk level score.

9. The method of claim 1, wherein the customer information includes compliance information.

10. The method of claim 1, wherein the presentation instrument is at least one of a savings account, a deposit account, a checking account, a money market account, a brokerage account, and a liability account.

11. The method of claim 1, further comprising:
receiving identification from the customer, wherein the identification is at least one of a driver's license, a government issued ID, a social security card, and a passport; and
based on availability and validity of the received identification, assigning the funding limit.

12. The method of claim 1, wherein the funding of the adjustable balance limit prepaid presentation instrument uses a variety of funding sources.

13. The method of claim 1, wherein the prepaid presentation instrument includes an associated monthly fee.

14. The method of claim 13, further comprising tracking usage of the prepaid presentation instrument account; and
tracking duration the customer has had the prepaid presentation instrument account.

15. The method of claim 14, further comprising based on at least one of the usage and the duration of the prepaid presentation instrument account, altering the associated monthly fee.

16. The method of claim 15, wherein the altering of the monthly fee comprises increasing the monthly fee in response to decreased usage and decreasing the monthly fee in response to increased usage and increased duration.

17. A method of converting a fixed limit prepaid presentation instrument into an adjustable balance limit prepaid presentation instrument, the method comprising:
presenting a customer's preexisting fixed limit prepaid presentation instrument;
analyzing the customer's usage history associated with the fixed limit prepaid presentation instrument;
based on the usage history, deriving a new funding limit; and
applying the new funding limit to the prepaid presentation instrument.

18. The method of claim 17, further comprising:
re-analyzing the customer's usage history;
based on the re-analysis, adjusting the funding limit of the prepaid presentation instrument; and
applying the adjusted funding limit to the prepaid presentation instrument.

19. The method of claim 17, wherein the funding limit is further based on the duration the customer has had the prepaid presentation instrument.

20. The method of claim 17, further comprising presenting, by a card issuer, a fixed limit prepaid presentation instrument to be converted to an adjustable limit prepaid presentation instrument.

21. A system for providing an adjustable balance limit prepaid presentation instrument, the system comprising:
a point-of-sale (POS) device configured to receive a request for an adjustable balance limit prepaid presentation instrument;
an account processor connected with the POS device via a financial network, configured to obtain customer information, wherein the account processor includes a decision engine configured, based on the customer information, to assign a funding limit to the adjustable balance limit prepaid presentation instrument; and
a banking network connected with the account processor configured to fund the adjustable balance limit prepaid presentation instrument to up to a maximum of the funding limit.

22. The system of claim 21, further comprising a call center configured to receive the customer information, to verify the customer's identity, and to transmit the customer information to the account processor.

23. The system of claim 21, wherein the account processor is further configured to store a customer profile for each customer based on the customer information, to maintain an accounting of customer transactions related to the adjustable balance limit prepaid presentation instrument, and to determine whether the adjustable balance limit prepaid presentation instrument has sufficient funds to fulfill a funds request.

24. A machine-readable medium for providing an adjustable balance limit prepaid presentation instrument, the machine-readable medium including sets of instruction which, when executed by a machine, cause the machine to:
receive a request for the adjustable balance limit prepaid presentation instrument;
obtain customer information;
based on the customer information, assign a funding limit to the adjustable balance limit prepaid presentation instrument; and
fund the adjustable balance limit prepaid presentation instrument to up to a maximum of the assigned funding limit using a variety of funding sources.

25. The machine-readable medium of claim 24, wherein the funding limit is determined based on how long the customer has had the adjustable balance limit prepaid presentation instrument.
